(19) United States
(12) Patent Application Publication
(10) Pub. No.: US 2014/0136066 A1
(43) Pub. Date: May 15, 2014

(54) METHOD OF SEARCHING FOR TOUCH POINT OF CLUTCH

(71) Applicants: HYUNDAI MOTOR COMPANY, Seoul (KR); KIA MOTORS CORP., Seoul (KR)

(72) Inventors: Sung Hyun Cho, Suwon-si (KR); Young Min Yoon, Seoul (KR); Joung Chul Kim, Suwon-si (KR); Seung Sam Baek, Jeju-si (KR)

(73) Assignees: Kia Motors Corp., Seoul (KR); Hyundai Motor Company, Seoul (KR)

(21) Appl. No.: 13/798,986

(22) Filed: Mar. 13, 2013

(30) Foreign Application Priority Data
Nov. 9, 2012 (KR) 10-2012-0126587

(51) Int. Cl. F16D 48/06

(52) U.S. Cl. CPC F16D 48/06
USPC 701/68

(57) ABSTRACT

A method of searching for a touch point of a clutch may include a reference measurement step of measuring angular acceleration of an input shaft while a gear of a non-drive shaft may be being engaged and disengaged, a clutch operation step of engaging the gear disengaged at the reference measurement step and manipulating a clutch of the input shaft to a currently stored touch point, a target measurement step of measuring angular acceleration of the input shaft while disengaging an engaged gear in a state of maintaining the clutch operated at the clutch operation step, and a learning step of learning and updating the touch point by comparing the angular acceleration of the input shaft measured at the target measurement step with the angular acceleration measured at the reference measurement step.

### CROSS-REFERENCE TO RELATED APPLICATION

The present application claims priority to Korean Patent Application No. 10-2012-0126587, filed on Nov. 9, 2012, the entire contents of which is incorporated herein for all purposes by this reference.

### BACKGROUND OF THE INVENTION

1. Field of the Invention

The present invention relates generally to a method of searching for the touch point of a clutch and, more particularly, to a technology that is capable of accurately maintaining the touch point of a dry clutch that is used in a double clutch transmission (DCT) that is mounted on a vehicle.

2. Description of Related Art

A DCT includes a clutch that is capable of automatically transmitting or blocking power using an actuator. When the clutch is a dry clutch, a touch point, that is, a point from which the clutch starts to operate, varies because of a change in the temperature of the clutch or the abrasion of the clutch, and thus it is necessary to appropriately adjust the touch point in order to maintain the reliable operability of the clutch.

FIG. 1 is a graph showing clutch torque characteristics for the strokes of a clutch actuator. When a stroke increases and then encounters a touch point, clutch torque actually starts to increase. when a clutch is in a normal state, the state in which the maximum clutch torque that is designed to be higher than the maximum engine torque that can be transmitted by an engine at the maximum stroke can be transmitted is entered. In contrast, when the touch point is moved because of a change in the temperature of the clutch or the abrasion of the clutch, the maximum torque of an engine is not sufficiently transmitted in the case of the maximum stroke.

As described above, the touch point is a factor that is related to the continuous and stable maintenance of the relationship of control between the clutch actuator and the clutch. FIG. 2 illustrates a conventional method of searching for and setting the touch point of a clutch. This method is performed when a vehicle is stopped or when a gearbox is in a neutral state immediately after the cranking of an engine.

That is, in the conventional method, the clutch actuator is manipulated from a location where the clutch is not engaged toward a location where the clutch is disengaged (“A”), the location of a clutch actuator from which the clutch starts to be rotated (“B”) is determined to be a touch point, this location is set as a new touch point (“C”), and the clutch actuator is manipulated based on the newly set touch point.

However, the above-described conventional method is problematic in that changes in the characteristics of the touch point that occur while a vehicle is being driven cannot be taken into consideration because the touch point can only be learned while a vehicle is stopped.

Accordingly, when the above-described change in the touch point attributable to the change in the state of the clutch cannot be appropriately tracked, an impact occurs during a change of speed, and thus operability is deteriorated or durability is degraded because of the occurrence of an excessive slip in the clutch.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method of searching for the touch point of a clutch, which enables a change in the touch point attributable to a change in the temperature of a clutch or the abrasion of the clutch to be appropriately tracked and the touch point to be set again, and thus an impact can be prevented during a change of speed, thereby ensuring the sensation of a smooth and soft change of speed and the durability of the clutch.

In an aspect of the present invention, a method of searching for a touch point of a clutch may include a reference measurement step of measuring angular acceleration of an input shaft while a gear of a non-drive shaft is being engaged and disengaged, a clutch operation step of engaging the gear disengaged at the reference measurement step and manipulating a clutch of the input shaft to a currently stored touch point, a target measurement step of measuring angular acceleration of the input shaft while disengaging an engaged gear in a state of maintaining the clutch operated at the clutch operation step, and a learning step of learning and updating the touch point by comparing the angular acceleration of the input shaft measured at the target measurement step with the angular acceleration measured at the reference measurement step.

Before the reference measurement step, a change-of-speed determination step of determining whether a vehicle is changing speed thereof and allowing the reference measurement step to be performed only when the vehicle is changing the speed thereof.

At the learning step, when the angular acceleration of the input shaft measured at the target measurement step is lower than the angular acceleration measured at the reference measurement step and thus a rotation speed of the input shaft is decreased more gradually, the touch point of the clutch is determined to may have been set to a point where the clutch is engaged.

At the learning step, the touch point is updated by moving the touch point backward to a point where the clutch is disengaged.

At the learning step, when the angular acceleration of the input shaft measured at the target measurement step is identical to the angular acceleration measured at the reference measurement step, the touch point of the clutch is determined to may have been set to a point where the clutch is disengaged.

At the learning step, the touch point is updated by moving the touch point forward to a point where the clutch is engaged.

At the learning step, when the angular acceleration of the input shaft measured at the target measurement step is lower than the angular acceleration measured at the reference measurement step and thus the rotation speed of the input shaft is decreased more gradually, the touch point of the clutch is determined to may have been set to a point where the clutch is engaged, and the touch point is moved toward a point where the clutch is disengaged depending on a difference between the angular acceleration measured at the reference measurement step and the angular acceleration of the input shaft measured at the target measurement step.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a graph showing clutch torques for the strokes of a conventional clutch actuator, which illustrates a touch point.

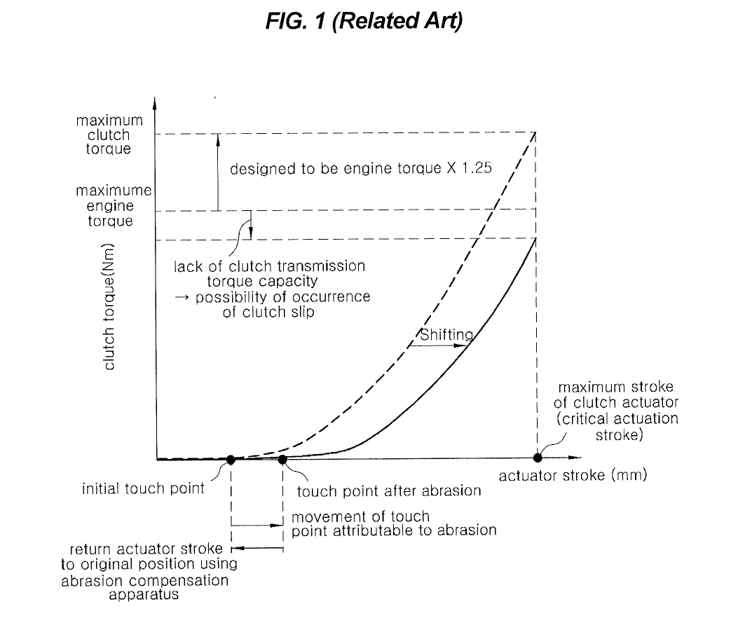

FIG. 2 is a flowchart showing a method of searching for the touch point of a clutch in accordance with an exemplary embodiment of the present invention.

FIG. 3 is a graph illustrating the method of searching for the touch point of a clutch in accordance with the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Reference now should be made to the drawings, throughout which the same reference numerals are used to designate the same or similar components.

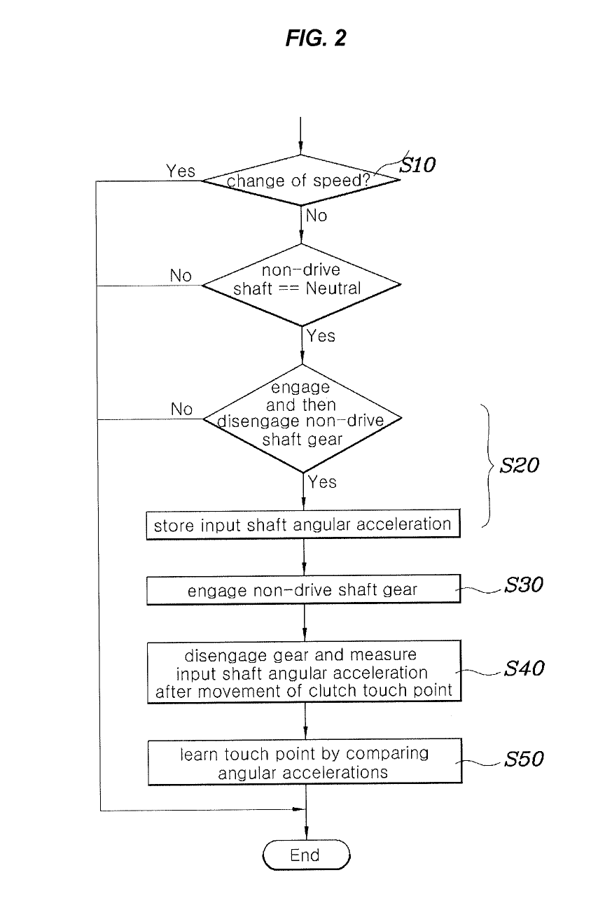

Referring to FIG. 2, a method of searching for the touch point of a clutch in accordance with an exemplary embodiment of the present invention includes reference measurement step S20 of measuring the angular acceleration of a corresponding input shaft while the gear of a non-drive shaft is being engaged and disengaged, clutch operation step S30 of engaging the gear disengaged at reference measurement step S20 and manipulating the clutch of the input shaft to a current touch point, target measurement step S40 of measuring the angular acceleration of the input shaft while disengaging the engaged gear in the state of maintaining the clutch operated at clutch operation step S30, learning step S50 of learning the touch point by comparing the angular acceleration of the input shaft measured at target measurement step S40 with the angular acceleration measured at reference measurement step S20.

Prior to reference measurement step S20, the method further includes change-of-speed determination step S10 of determining whether a vehicle is changing its speed and allowing reference measurement step S20 to be performed only when the vehicle is changing its speed.

That is, when it is determined at change-of-speed determination step S10 that the vehicle is at a normal driving state in which a change of speed is not made while the vehicle is being driven, reference measurement step S20 is performed while the gear of the current non-drive shaft is being engaged and disengaged, angular acceleration is measured when the rotation speed of the input shaft, that is, the non-drive shaft, is decreased by the disengagement of the gear and then stored, angular acceleration is measured when the rotation speed of the input shaft is decreased by the performance of clutch operation step S30 and target measurement step S40, and the angular accelerations are compared with each other at learning step S50, thereby determining the propriety of the current touch point and updating the touch point with an appropriate value.

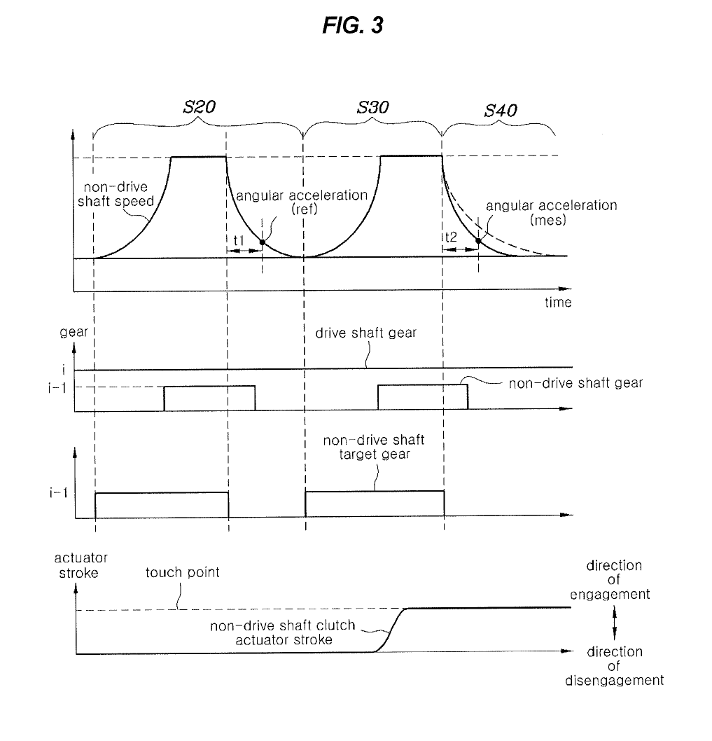

Referring to FIG. 3 together with FIG. 2, at reference measurement step S20, when the speed of the non-drive shaft gear is increased by the engagement of the gear and decreased by the disengagement of the gear, that is, at a point in time that comes after t1 has elapsed after the issuance of a command to disengage the target gear of the non-drive shaft and thus the gear of the non-drive shaft has been substantially disengaged, the angular acceleration of the input shaft, that is, the non-drive shaft, is measured and set as a reference value ref.

Thereafter, at a point in time that comes after the same gear of the non-drive shaft had been engaged again at clutch operation step S30 and t1 has elapsed after the issuance of a command to disengage the target gear of the non-drive shaft at target measurement step S40 so that the gear of the non-drive shaft has been disengaged, the angular acceleration of the input shaft, that is, the non-drive shaft, is measured and set as a measured value mes, and is compared with the reference value ref at learning step S50.

Here, the input shaft and the non-drive shaft refer to the same shaft, which refers to the remaining input shaft other than the input shaft that forms the current drive shift stage of the vehicle. Although the angular acceleration is angular deceleration in nature, the later term is not intuitive, and thus the meaning of the former term is clarified by adding the term “gradual” or “steep” to the term “angular acceleration.” The fact that the angular acceleration is high means that the rotation speed decreases rapidly because the change in the rotation speed of the input shaft is high.

At learning step S50, when the angular acceleration of the input shaft measured at target measurement step S40 is lower than the angular acceleration measured at reference measurement step S20 and thus the rotation speed of the input shaft is decreased more gradually, the touch point of the clutch is determined to have been set to a point where the clutch is engaged.

That is, when the measured value mes, that is, the angular acceleration measured at target measurement step S40, is lower than the reference value ref measured at reference measurement step S20 and thus the rotation speed of the input shaft is more gradually decreased, the clutch is engaged further than the substantial touch point when the clutch actuator stroke of the corresponding clutch manipulates the clutch to the currently stored touch point. Since the speed at which the rotation speed decreases is caused to be relatively gradual by the power supplied to the engine via the clutch even in the state in which the input shaft is supplied with power by a driving wheel because of the release of the gear, the propriety of the touch point is determined using it.

Furthermore, at learning step S50, when the angular acceleration of the input shaft measured at target measurement step S40 is the same as the angular acceleration measured at reference measurement step S20, the touch point of the clutch is determined to have been set to a point where the clutch is disengaged.

That is, the fact that the measured value mes, that is, the angular acceleration measured at target measurement step S40, is the same as the reference value ref measured at reference measurement step S20 means that when the actuator stroke of the corresponding clutch manipulates the clutch to the currently stored touch point, the clutch is not substantially engaged to the touch point, and thus the power of the engine is not transmitted to the input shaft via the clutch when the angular acceleration is measured at target measurement step S40. This may be interpreted to mean that the current touch point has not been set to an appropriate touch point.

Accordingly, at learning step S50, it may be possible to update the touch point using a method of gradually moving the touch point forward to a point where the clutch is engaged when the measured value mes is the same as the reference value ref and moving, by one step, the touch point backward to a point where the clutch is disengaged when the measured value mes is lower than the reference value ref and thus the rotation speed is gradually decreased.

Furthermore, at learning step S50, when the angular acceleration of the input shaft mes measured at target measurement step S40 is lower than the angular acceleration res measured at reference measurement step S20 and thus the rotation speed of the input shaft is decreased more gradually, the touch point of the clutch is determined to have been set to a point where the clutch is engaged, and the touch point is moved toward a point where the clutch is disengaged. In this case, the amount of movement is varied depending on the difference between the reference value ref and the measured value mes, and thus the rapid and appropriate setting of the touch point is enabled.

The method of searching for the touch point of a clutch in accordance with the exemplary embodiment of the present invention provides the advantage of enabling a change in the touch point attributable to a change in the temperature of a clutch or the abrasion of the clutch to be appropriately tracked and the touch point to be set again, and thus an impact can be prevented during a change of speed, thereby ensuring the sensation of a smooth and soft change of speed and the durability of the clutch.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of searching for a touch point of a clutch, comprising:
a reference measurement step of measuring angular acceleration of an input shaft while a gear of a non-drive shaft is being engaged and disengaged;
a clutch operation step of engaging the gear disengaged at the reference measurement step and manipulating a clutch of the input shaft to a currently stored touch point;
a target measurement step of measuring angular acceleration of the input shaft while disengaging an engaged gear in a state of maintaining the clutch operated at the clutch operation step; and
a learning step of learning and updating the touch point by comparing the angular acceleration of the input shaft measured at the target measurement step with the angular acceleration measured at the reference measurement step.

2. The method of claim 1, further comprising:
before the reference measurement step, a change-of-speed determination step of determining whether a vehicle is changing speed thereof and allowing the reference measurement step to be performed only when the vehicle is changing the speed thereof.

3. The method of claim 1, wherein, at the learning step, when the angular acceleration of the input shaft measured at the target measurement step is lower than the angular acceleration measured at the reference measurement step and thus a rotation speed of the input shaft is decreased more gradually, the touch point of the clutch is determined to have been set to a point where the clutch is engaged.

4. The method of claim 3, wherein, at the learning step, the touch point is updated by moving the touch point backward to a point where the clutch is disengaged.

5. The method of claim 1, wherein, at the learning step, when the angular acceleration of the input shaft measured at the target measurement step is identical to the angular acceleration measured at the reference measurement step, the touch point of the clutch is determined to have been set to a point where the clutch is disengaged.

6. The method of claim 5, wherein, at the learning step, the touch point is updated by moving the touch point forward to a point where the clutch is engaged.

7. The method of claim 1, wherein, at the learning step, when the angular acceleration of the input shaft measured at the target measurement step is lower than the angular acceleration measured at the reference measurement step and thus the rotation speed of the input shaft is decreased more gradually, the touch point of the clutch is determined to have been set to a point where the clutch is engaged, and the touch point is moved toward a point where the clutch is disengaged depending on a difference between the angular acceleration measured at the reference measurement step and the angular acceleration of the input shaft measured at the target measurement step.
